(19) United States
(12) Patent Application Publication
(10) Pub. No.: US 2003/0195763 A1
(43) Pub. Date: Oct. 16, 2003

(54) Method and system for managing a distributed workflow

(75) Inventors: Ceki Gulcu, Lausanne (CH); Yigal Hoffner, Zurich (CH); Heiko Ludwig, New York, NY (US)

Correspondence Address: Peter M. Klett, Intellectual Property Law Dept., IBM Corporation, P.O. Box 218, Yorktown Heights, NY, 10598, US

(73) Assignee: International Business Machines Corporation, Armonk, NY

(21) Appl. No.: 10/287,920

(22) Filed: Nov. 4, 2002

(30) Foreign Application Priority Data
Apr. 11, 2002 (EP) 02368039.0

(51) Int. Cl. G06F 17/60

(52) U.S. Cl. 705/1

(57) ABSTRACT

A method and system is proposed for managing a workflow distributed among at least two participating entities by means of respective distinct computer-based workflow management systems in each entity. Each workflow management system manages a respective workflow part of the distributed workflow. A common specification of the distributed workflow is defined as a reference by the workflow management systems. The common workflow specification specifies which workflow management system is in charge of managing which workflow part. Additionally, within each workflow management system a respective image of the distributed workflow is created, based on which the workflow management system of one entity is notified of the progress of the workflow part managed by the other workflow management system. In the notified workflow management system, an indication of progress on the distributed workflow image is kept updated in line with the progress of the workflow part managed by the other workflow management system. In each wms a table of activities can be created containing for each activity an activity classifier classifying the activity as a local activity to be managed locally or a remote activity to be managed remotely by another workflow management system. A Each workflow management system comprises a workflow server, at least one workflow client and means for exchanging information and keeping the workflow management system updated, interacting with the workflow server as a workflow client.

### TECHNICAL FIELD

The present invention relates to data processing system, and more specifically to workflow management system running on a data processing system.

### BACKGROUND ART

The process of designing, developing and manufacturing new products and the process of changing or adapting existing products present many challenges to product managers and engineers to bring the products to market at low cost and within schedule while maintaining or even increasing product quality. Many companies are realizing that the conventional product design process may not be satisfactory to meet these needs. Thus, these companies may involve manufacturing engineering, cost engineering, logistic planning, procurement, manufacturing, service and support early in the design effort. Furthermore, they may plan and control product data through design, release and manufacturing.

The correct and efficient execution of business processes within a company, such as the development or production processes, may be of enormous importance for a company and may have a significant influence on company's overall success in the marketplace. Therefore, business processes are being regarded similarly to technology processes, and are being tested, optimized and monitored.

Computer-based workflow management systems (WfMSs) have thus been developed that support the modeling and execution of business processes.

It may happen that a whole or part of a business process is executed across multiple participating organizations. This is for example the case of a business process the execution of which is wholly or partly outsourced by an organization (the customer organization) to a provider organization.

Current workflow management systems do not allow different participating organizations to follow the progress of the process as a whole, i.e. not only of the parts of the process executed locally, but also of the parts of the process executed in the other organizations. For example, current workflow management systems do not allow the customer organization following the progress of the outsourced process in the provider organization.

### SUMMARY OF THE INVENTION

It is an object of the present invention to overcome the limitations of current workflow management systems.

More generally, it is an object of the present invention to improve the cooperation of different entities participating to a common, distributed workflow.

According to the present invention, this and other objects are achieved by means of a method as set forth in appended claim 1, for managing a workflow distributed among at least two participating entities by means of respective distinct computer-based workflow management systems in each entity, each workflow management system managing a respective workflow part of the distributed workflow.

A common specification of the distributed workflow is defined, used as a reference by the workflow management systems. The common workflow specification specifies which workflow management system is in charge of managing a workflow part.

Additionally, a respective image of the distributed workflow is created within each workflow management system.

Based on the common workflow specification, the workflow management system of one entity communicates the progress of the workflow part managed by the workflow management system to the other entity.

In the notified workflow management system, an indication of progress on the distributed workflow image is updated in line with the progress of the workflow part managed by the workflow management system of the other entity.

### BRIEF DESCRIPTION OF THE DRAWINGS

The features and advantages of the present invention will be made apparent by the following detailed description of an embodiment thereof, provided by way of a non-limiting example, which will be made with reference to the attached drawings, wherein:

FIG. 1 schematically shows two entities, e.g. two organizations participating to the execution of a common business process, each having a computer-based workflow management system implementing a state-shadowing mechanism;

FIG. 2 shows in terms of functional blocks the main components of a state-shadowing engine, provided in each workflow management system for implementing the state-shadowing mechanism;

FIG. 3A schematically shows a shadow table created by the state-shadowing engine of one of the two organizations of FIG. 1 for implementing the state-shadowing mechanism in the execution of an exemplary business process;

FIG. 3B schematically shows a corresponding shadow table created by the state-shadowing engine of the other organization;

FIG. 4A shows the evolution of the state of the two workflow management systems during the execution of the exemplary business process;

FIG. 4B shows a common view of the exemplary business process shared by the workflow management systems of the two participating organizations by virtue of the state-shadowing mechanism.

FIG. 5 is a flowchart of the state-shadowing algorithm implemented by the state-shadowing engine;

FIGS. 6A. schematically show the routing of different and 6B. workflow system management operations;

FIG. 7 is a flowchart of the operation of the state-shadowing engine when dealing with different management operations;

FIG. 8 schematically shows a situation in which each workflow management system has an internal representation of the exemplary business process different from the process common view.

### DETAILED DESCRIPTION OF THE PREFERRED EMBODIMENT

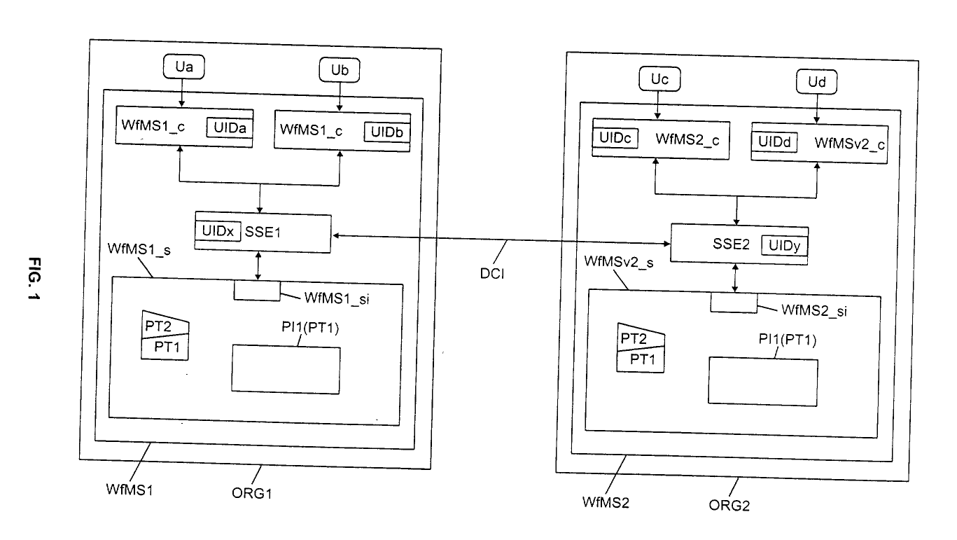

With reference to the drawings, FIG. 1 shows at a high level two organizations ORG1, ORG2 participating to the execution of a common business process. For example, the two organizations ORG1, ORG2 are peer organizations of a same enterprise or company, each of which is in charge of the execution of a respective part of the common business process; alternatively, one organization, e.g. organization ORG1, is a customer organization that has outsourced the execution of all or part of the business process to the organization ORG2, the provider organization. It is intended that, albeit only two organizations are considered in this example for the sake of simplicity, the present invention straightforwardly applies also in case the organizations participating to the execution of a common business process are more than two.

Each organization ORG1, ORG2 participating to the execution of the business process, in the following referred to as participating organization, has a respective workflow management system WfMS1, WfMS2, for the management of the respective part of the business process. In particular, in each participating organization ORG1, ORG2 the respective workflow management system WfMS1, WfMS2 is a computer-based management system running on a respective data processing system of that organization. The data processing system in each organization ORG1, ORG2 may include one or, more typically, several personal computers or workstations, interconnected through a data communication network, such as a local area network (LAN), a wide area network (WAN) where the organization is spread on different geographic locations, the Internet.

The workflow management system WfMS1, WfMS2 in each participating organization ORG1, ORG2 conventionally includes a workflow management system server WfMS1_S, WfMS2_S, in the following simply referred to as workflow server. The workflow server WfMS1_S, WfMS2_S is a server computer application, running on a dedicated or general-purpose personal computer or workstation of the data processing system behaving as the server of the workflow management system WfMS1, WfMS2. The workflow server WfMS1_S, WfMS2_S updates and persistently maintains information about the state of execution of the respective part of the business process. State changes are determined by operations in the workflow.

A workflow management system allows modeling a business process as a syntactical unit in a way that is directly supported by a data processing system. Once the model of a business process is created, it forms a template for a class of similar processes performed within an enterprise or company. The process template can be instantiated, interpreted by the data processing system and the individual sequence of work steps required to carry out the business process can be determined; the sequence of work steps will depend on the context of the instantiation of the process template. An instance of the process template and its interpretation represent an individual process. The fundamental elements of a process template are called activities: an activity represents a business action that can be viewed as a semantical entity. The process template describes the workflow activities, their execution order and the resources assigned to them. As schematically shown in FIG. 1, the workflow servers WfMS1_S, WfMS2_S store, for example, on the hard disk of the personal computer or workstation acting as the server of the workflow management system, a plurality of process templates PT1, PT2, . . . ; a process instance PI1(PT1) of the process template PT1 is also schematically shown as running on the workflow server WfMS1_S, while a corresponding process instance PI1′ (PT1) of the same process template PT1 is running on the workflow server WfMS2_S.

In each participating organization ORG1, ORG2, the workflow server WfMS1_S, WfMS2_S interacts with a respective state-shadowing engine SSE1, SSE2, running on the respective data processing system, for example on the same server computer or workstation on which the workflow server runs.

Also, in each participating organization ORG1, ORG2, a plurality of workflow management system clients WfMS1_C, WfMS2_C, in the following simply referred to as workflow clients, interact with the workflow server WfMS1_S, WfMS2_S through an interface provided by the respective state-shadowing engine SSE1, SSE2. The workflow clients WfMS1_C, WfMS2_C are client computer applications running on personal computers or workstations of the data processing system. Using the workflow clients WfMS1_C, WfMS2_C, users Ua, Ub, Uc, Ud of the workflow management systems WfMS1, WfMS2 in the organizations ORG1, ORG2 can interact with the workflow management system WfMS1, WfMS2 of the organization to which they belong.

The workflow server WfMS1_S, WfMS2_S is equipped with an interface WfMS1_SI, WfMS2_SI allowing the users Ua, Ub, Uc, Ud within the organization ORG1, ORG2, operating through the workflow clients WfMS1_C, WfMS2_C, to log on the respective workflow server, read and possibly modify the state of activities (e.g., START, TERMINATE, COMPLETE) executed in that organization. Different users have respective user identifiers UIDa, UIDb, UIDc, UIDd, enabling the workflow clients WfMS1_C, WfMS2_C to interact with the workflow server WfMS1_S, WfMS2_S to read and modify the state of the workflow management system. Different levels of privilege can be assigned to the different user identifiers, so that different users are allowed to interact at different levels of privilege with the workflow management system. For example the user Ua, having the user identifier UIDa, can be assigned the privilege of reading and modifying the state of the workflow management system WfMS1, while the user Ub, having the user identifier UIDb, is assigned a lower privilege and can only read the state of the workflow management system WfMS1.

The state-shadowing engines SSE1, SSE2 of the two organizations ORG1, ORG2 interact with each other. The interaction is made possible by any suitable data communication infrastructure DCI connecting the data processing systems of the two organizations ORG1, ORG2, such as a LAN, a WAN, the Internet.

Each state-shadowing engine SSE1, SSE2 implements a state-shadowing mechanism, allowing the users in any one of the organizations participating to the execution of the common business process to follow the evolution of the workflow in the other participating organizations. For example, the state-shadowing mechanism allows the users Ua, Ub of the workflow management system WfMS1 in the organization ORG1 following the workflow evolution in the organization ORG2, and vice-versa.

In particular, the state-shadowing mechanism implemented by the state-shadowing engines SSE1, SSE2 allows creating in the workflow management system WfMS1, WfMS2 of each participating organization ORG1, ORG2 an internal replica, or a shadow, of that part of the common business process which is executed by the other organizations.

Whenever an action is performed by one of the participating organizations, e.g. the organization ORG2, in the execution of the respective part of the common business process, the local workflow management system changes state and, through the respective state-shadowing engine, sends to the workflow management systems of the other participating organizations, e.g. the organization ORG1, a message informing of the state change. The state-shadowing engines of the other participating organizations receive the message; the message is translated into a form suitable to effect corresponding state changes that allow the local workflow management system replicating the state of the workflow management system of the organization ORG2.

In one embodiment of the present invention, the state-shadowing engine SSE1, SSE2 expediently exploits the existing interface WfMS1_SI, WfMS2_SI of the associated workflow server WfMS1_S, WfMS2_S for interacting therewith. To this purpose, the state-shadowing engine SSE1, SSE2 is assigned a respective user identifier UIDx, UIDy, having a suitably high level of privilege. The state-shadowing engine SSE1, SSE2 uses the user identifier UIDx, UIDy for logging onto the respective workflow server WfMS1_S, WfMS2_S. The state-shadowing engine is thus seen as a workflow client by the respective workflow server.

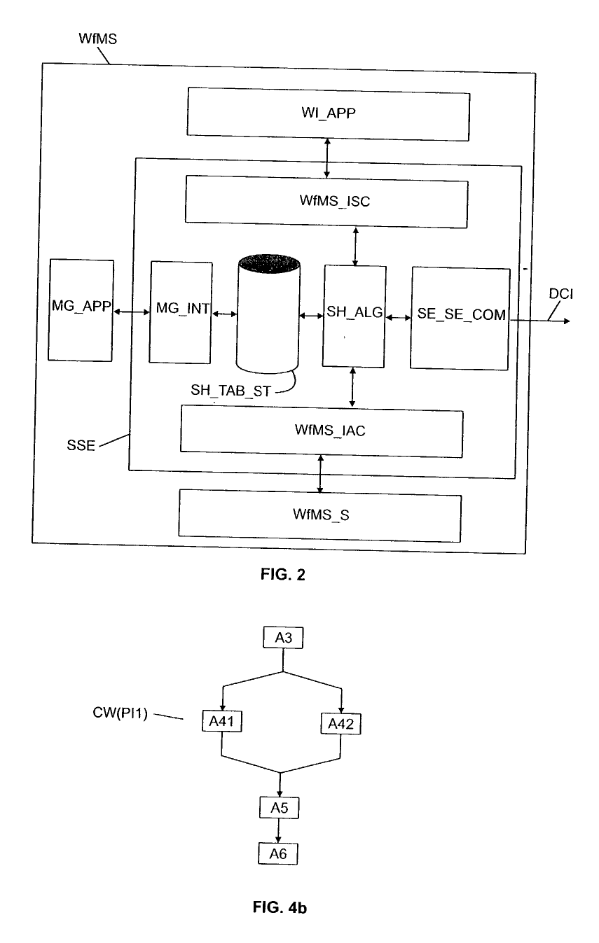

FIG. 2 schematically shows, in terms of functional blocks, the main components of a state-shadowing engine according to an embodiment of the present invention.

The state-shadowing engine, globally identified by SSE and part of a workflow management system WfMS, includes a state-shadowing algorithm implementing component SH_ALG, a workflow management system interface simulation component WfMS_ISC, a workflow management system interface adaptation component WfMS_IAC, a shadow table storage component SH_TAB_ST, a management interface component MG_INT and a communication component SE-SE_COM.

The workflow management system interface simulation component WfMS_ISC allows the state-shadowing engine SSE interfacing with one or more workflow applications Wf_APP, running under a workflow client. The interface simulation component WfMS_ISC implements and simulates a standard workflow server interface, such as the interfaces WfMS1_SI, WfMS2_SI of FIG. 1, that conventionally allows the workflow application Wf_APP interfacing with the workflow server WfMS_S. In particular, the interface simulation component WfMS_ISC supports the same standard functions, in the same form, as a conventional workflow server interface; the set of functions includes for example standard function sets such as WFMC IF 2, OMG Workflow Facility, and functional interfaces of conventional workflow management systems, such as MQWF, FileNet, Staffware etc.

The workflow management system interface adaptation component WfMS_IAC maps the process management functions used by the state-shadowing algorithm implementing component SH_ALG onto functions that are supported by the underlying workflow server WfMS_S. In particular, the mapped functions can be proprietary to a particular workflow management system, or they can belong to standard function sets.

The state-shadowing algorithm implementing component SH_ALG is the core of the state-shadowing engine. The state-shadowing algorithm implementing component SH_ALG accesses the shadow table storage component SH_TAB_ST, used to persistently store shadow tables on which the operation of the state-shadowing engine is based. The shadow table storage component SH_TAB_ST is for example the hard disk of the personal computer or workstation acting as the server of the workflow management system.

The management interface component MG_INT enables one or more management application components MG_APP, external to the state-shadowing engine SSE, to access the shadow table storage component SH_TAB_ST for reading and writing the shadow tables. The management application component MG_APP is for example a computer application running on a personal computer or workstation coincident with or distinct from the personal computer or workstation acting as the server of the workflow management system, allowing authorized users to access the shadow table storage component SH_TAB_ST.

The communication component SE-SE_COM enables the state-shadowing engine SSE to interact with other state-shadowing engines in the workflow management systems of other participating organizations, over the data communication infrastructure DCI.

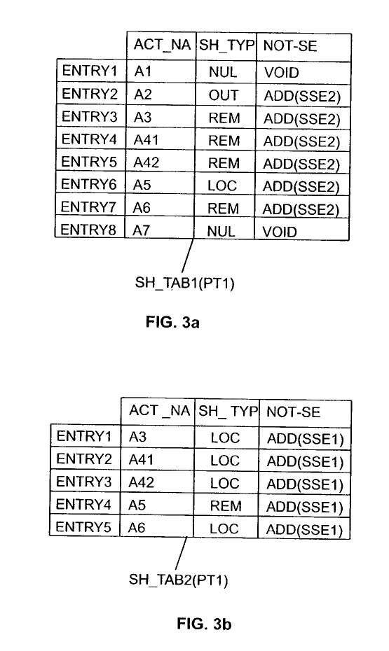

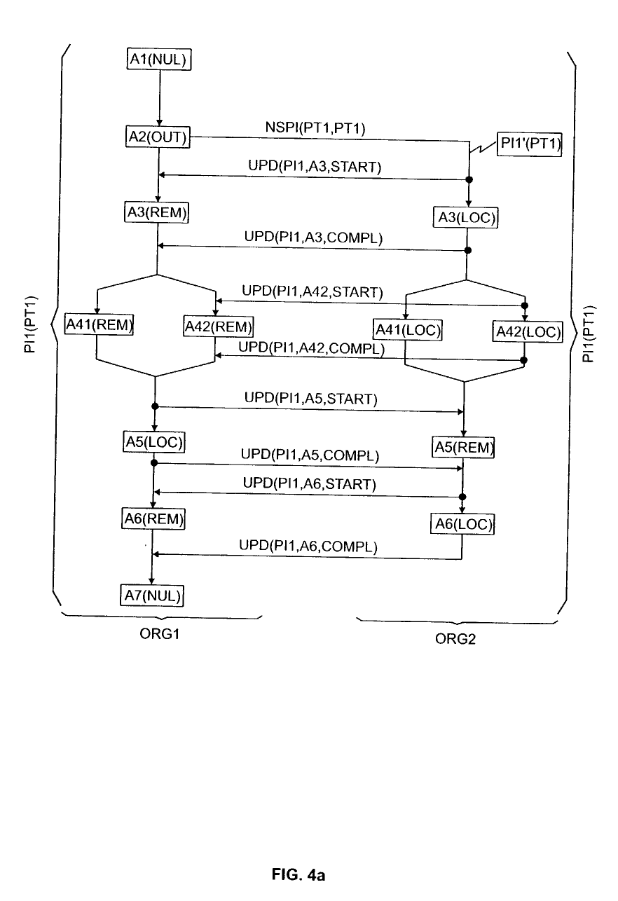

FIG. 3A schematically shows a shadow table, according to an embodiment of the present invention. A shadow table is created by the state-shadowing algorithm implementing component SH_ALG of the state-shadowing engine SSE1, SSE2 of one of the participating organizations ORG1, ORG2 each time a process template PT1, PT2, modeling a given process type, in the workflow management system WfMS1, WfMS2 is instantiated. Once created, the shadow table is stored in the respective shadow table storage component SH_TAB_ST.

In one embodiment of the invention, a shadow table template is created for each process template. The shadow table templates are created using the management application component MG_APP and, through the management interface component MG_INT, are loaded into the workflow management system WfMS and stored in the shadow table storage component SH_TAB_ST. The shadow table templates contain a description of how an instance of the shadow table template, or shadow table, is to be created by the state shadowing algorithm implementing component SH_ALG, upon detecting that a given process template has been instantiated.

In particular, the shadow table shown in FIG. 3A, identified globally by SH_TAB1(PT1), is created by the state shadowing engine SSE1 and stored in the respective shadow table storage component SH_TAB_ST when the process template PT1 is instantiated in the workflow management system WfMS1. The instantiation of the process template PT1 creates the process instance PI1(PT1). By way of example only, the individual process corresponding to the process instance PI1(PT1) is supposed to include eight activities named A1, A2, A3, A41, A42, A5, A6, A7: the activities named A1, A2, A5 and A7 are to be performed within the organization ORG1, while the activities named A3, A41, A42 and A6 are to be performed within the organization ORG2; the activities A41 and A42 are supposed to be alternative to each other. It is also assumed that the order of execution of the activities specified in the process template PT1 is: A1->A2->A3->A41 or A42->A5->A6->A7. It is observed that the number, type and execution sequence of the activities comprising the process instance PI1(PT1) are normally context-dependent, i.e. they depend on the context of instantiation of the process template PT1.

The shadow table SH_TAB1(PT1) has as many entries ENTRY1 ENTRY8 as the activities of the process instance PI1(PT1). Any entry ENTRY1-ENTRY8 of the shadow table SH_TAB1(PT1) has three fields ACT_NA, SH_TYP, NOT_SE. A first field ACT_NA contains the name A1-A8 of a respective one of the activities, or in general an activity identifier. A second field SH_TYP contains an activity classifier NUL, LOC, REM, OUT, allowing the state-shadowing algorithm implementing component SH_ALG to identify to which class the activity belongs. A third field NOT_SE contains, depending on the class to which the activity belongs, the list of state-shadowing engines of other participating organizations to or from which activity execution requests or notifications need to be sent or received.

Four classes of activities are provided.

A first class of activities, identified by the activity classifier REM (“remote shadow”) such as the activities A3, A41, A42 and A6 in the shown example, includes remotely-executed (in the following, simply remote) activities, i.e. activities to be performed within the other participating organization ORG2, under the control of the respective workflow management system WfMS2, the state of execution of which is shadowed locally in the workflow management system WfMS1 of the organization ORG1. If an activity is classified as remote, the third field NOT_SE contains an information representing the address ADD(SSE2) of the state-shadowing engine SSE2 associated with the workflow management system WfMS2 managing the execution of the activity.

A second class of activities, identified by the activity classifier LOC (“local shadow”) such as the activity A5 in the shown example, includes locally-executed (in the following, simply local) activities, i.e. activities performed locally within the organization ORG1 under the control of the workflow management system WfMS1. The execution of these local activities is shadowed by the workflow management system WfMS2 in the other participating organization ORG2. If an activity is classified as local, the field NOT_SE of the corresponding entry of the shadow table contains an information representing the address ADD(SSE2) of the state-shadowing engine SSE2 of the workflow management system WfMS2, to which notifications of state changes in consequence of the execution of the local activity are to be sent by the state-shadowing engine SSE1. More generally, in the case of multiple participating organizations, the field NOT_SE contains the addresses of the state-shadowing engines of all the other participating organizations.

A third class of activities, identified by the activity classifier NUL (“null shadow”) such as the activities A1 and A7 in the shown example, includes activities which are executed locally within the organization ORG1, under the control of the workflow management system WfMS1, and which are not shadowed in the workflow management system WfMS2 of the other participating organization ORG2. In this case, the field NOT_SE is void, because the state-shadowing engine SSE2 (more generally, the state-shadowing engines of all the other participating organizations) needs not be notified of state changes produced by the execution of these activities.

A fourth class of activities, identified by the activity classifier OUT (“outsourced shadow”) such as the activity A2 in the shown example, includes activities determining the start of a shadowed process part. The field NOT_SE in the corresponding shadow table entry contains the address ADD(SSE2) of the state-shadowing engine SSE2 of the other organization ORG2 participating to the execution of the common business process. This address is used to notify the workflow management system WfMS2 of the other participating organization ORG2 that a new shadowed process instance PI1(PT1) of the process template PT1 has been created.

FIG. 3B shows a shadow table SH_TAB2(PT1) created by the state-shadowing engine SSE2, and stored in the respective shadow table storage component SH_TAB_ST, when the workflow management system WfMS2 instantiates the process template PT1 upon receiving the prescribed notification from the state-shadowing engine SSE1. The shadow table SH_TAB2(PT1) contains only those activities, namely A3, A41, A42, A5 and A6 in the shown example, which are either performed in the organization ORG1 and shadowed in the organization ORG2, or performed in the organization ORG2 and shadowed in the organization ORG1. The activities classified as NUL, such as A1 and A7, which are performed in the organization ORG1 and not shadowed in the workflow management system WfMS2 of the organization ORG2, are not included in the shadow table SH_TAB2(PT1). It is to be observed that the process template PT1 may also include activities to be executed within the organization ORG2 and not to be shadowed in the workflow management system WfMS1 of the organization ORG1. It can be seen that the activities that in the shadow table SH_TAB1(PT1) are classified as REM (remote activities) and assigned to the organization ORG2 (ADD(SSE2) in the field NOT_SE of the corresponding entry of the shadow table), are dually classified as LOC (local activities) in the shadow table SH_TAB(PT1), and vice-versa.

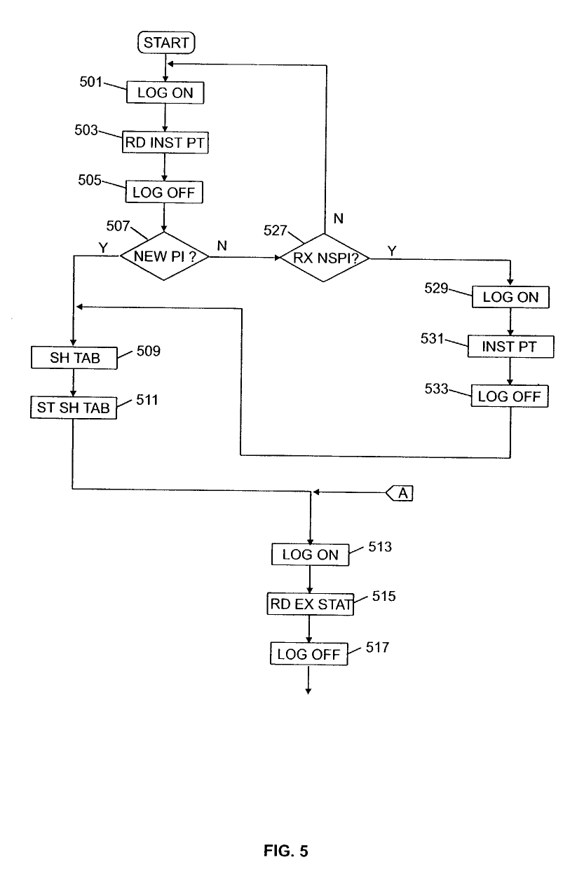

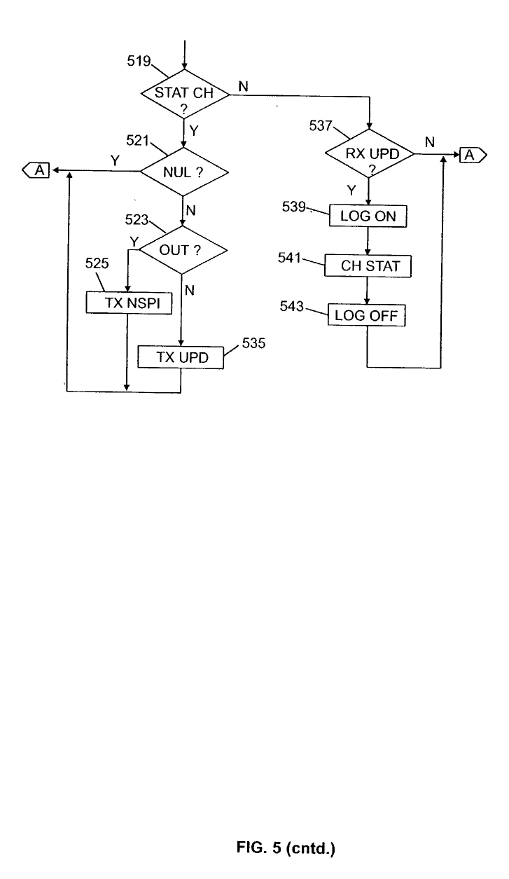

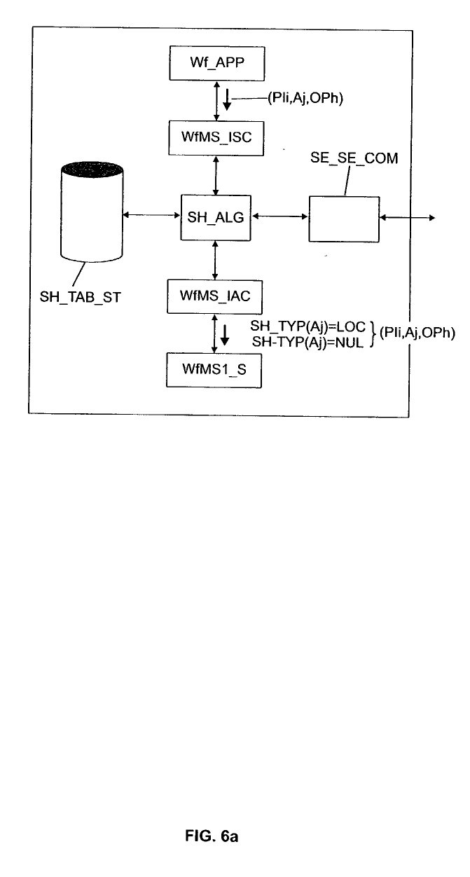

The state-shadowing mechanism will be now described with the aid of the diagram of FIG. 4A, schematically illustrating the workflow of the process instance PI1(PT1) of the process template PT1, and the flowchart of FIG. 5, schematically showing the flow of actions performed by any of the state-shadowing engines. It is assumed that the activity A1 is the start activity of the process, and the activity A7 is the end activity.

Using the assigned user identifier UIDx, the state-shadowing engine SSE1 periodically logs onto the workflow server WfMS1_S to control if a process template has been instantiated by the workflow management system WfMS1 of the organization ORG1 to create the individual process, or process instance (blocks 501, 503, 505 and 507 in FIG. 5). Let it be assumed that, at a given time, the state-shadowing engine SSE1 detects that the process template PT1 is instantiated, so that the process instance PI1(PT1) is created. In response thereto, the state-shadowing algorithm implementing component SH_ALG of the stahe-shadowing engine SSE1 creates (block 509) and stores in the respective shadow table store component SH_TAB_ST (block 511) the shadow table SH_TAB1(PT1) of FIG. 3A.

Under the control of the workflow server WfMS1_S of the workflow management system WfMS1, the start activity A1 is located, the respective assigned resources (e.g. the people working team) are determined and the activity A1 is posted onto a work list of the selected people of the working team. When a user belonging to the selected working team selects the activity (through the respective workflow client WfMS1_C), the activity A1 is executed and removed from the work list. The execution of the activity A1 produces a result, constituting the exit condition of the activity. The exit condition of the activity A1 is evaluated by the workflow server WfMS1_S and, if proper, the activity A1 is considered completed.

The state-shadowing engine SSE1 continues to periodically log onto the workflow server WfMS1_S to read the state of execution of the process instance PI1(PT1) and verifies if any state change has occurred (blocks 513, 515, 517 and 519). Since the start activity A1 is classified as NUL in the shadow table SH_TAB1(PT1), the state-shadowing engine SSE1 does not notify state changes of the workflow management system WfMS1 related to the execution of the activity A1 to the state-shadowing engine SSE2 of the workflow management system WfMS2 in the other participating organization ORG2 (block 521).

The state-shadowing engine continues to read the state of the execution of the instantiated process PI1(PT1). Once the activity A1 is completed, the workflow server WfMS1_S of the workflow management system WfMS1 locates the next activity A2 in the workflow to performed. The state-shadowing algorithm implementing component SH_ALG in the state-shadowing engine SSE1, looking at the shadow table SH_TAB1(PT1), detects that the activity A2 is classified as OUT (block 523). This causes the state-shadowing engine SSE1 to send a notification NSPI(PT1,PI1) (“new shadowed process instance PI1 of process template PT1”) to the state-shadowing engine SSE2 in the workflow management system WfMS2 of the participating organization ORG2 (block 525). The notification is sent through the communication component SE-SE_COM over the data communication infrastructure DCI linking the data processing systems in the two organizations ORG1, ORG2, using the address ADD(SSE2) of the state-shadowing engine SSE2 stored in the field NOT_SE of the shadow table SH_TAB1(PT1) entry ENTRY2 corresponding to the activity A2.

Similarly to the state-shadowing engine SSE1, the state-shadowing engine SSE2 periodically logs onto the workflow server WfMS1_S of the workflow management system WfMS2, using the assigned user identifier UIDy (blocks 501, 503 and 505). When the state-shadowing engine SSE2 receives the notification NSPI(PT1,PI1) (block 527), the state-shadowing engine SSE2 logs onto the workflow server WfMS2_S and causes the creation of a process instance PI1′ (PT1) of the process template PT1 (blocks 529, 531 and 533); the process instance PI1′ (PT1) includes the activities and control flow comprising the part of the business process which comprises activities to be executed within the organization ORG2 but shadowed in the organization ORG1, or vice-versa. In this example, the process instance PI1′ (PT1) includes the activities A3, A41, A42, AS and A6, and the associated control flow.

The instantiation PI1′ (PT1) of the process template PT1 by the workflow server WfMS2_S causes the associated state-shadowing engine SSE2 to create (block 509) and store (511) in the respective shadow table store component SH_TAB_ST the shadow table SH_TAB2(PT1) shown in FIG. 3B.

In this way, a common view CW(PI1) (shown in FIG. 4B) of the business process is defined, agreed by the workflow management systems WfMS1, WfMS2 of both the participating organizations ORG1, ORG2.

The workflow management system WfMS2 locates the start activity A3 in the process instance PT1′ (PT1), locates the resources assigned to the execution and posts the activity A3 onto the work list of the selected team of people.

The state-shadowing algorithm implementing component SH_ALG of the state-shadowing engine SSE2, continuing to periodically log onto the workflow server WfMS2_S (blocks 513 to 519), detects a change in the state of execution of the process instance PI1′ (PT1) related to the starting of the execution of the activity A3. Looking at the shadow table SH_TAB2(PT1), the state-shadowing algorithm implementing component SH_ALG in the state-shadowing engine SSE2 detects that the activity A3 is classified as LOC and sends (block 535) to the state-shadowing engine SSE1 (whose address ADD(SSE1) is stored in the field NOT_SE of the entry ENTRY1 of the shadow table SH_TAB2(PT1)) a notification UPD(PI1,A3,START) (“update: started activity A3 of process instance PI1(PT1)”). The state-shadowing engine SSE1 receives the notification UPD(PI1,A3,START) (block 537), and logs onto the workflow server WfMS1_S of the workflow management system WfMS1 as a user, using the assigned user identifier UIDx (block 539). Once logged on, the state-shadowing engine SSE1 supplies to the workflow server WfMS1_S, through the respective interface adapter component WfMS_IAC, management commands such as to cause the workflow server WfMS1 to start the activity A3, thereby changing the state of the workflow management system WfMS1 (block 541); then, the state-shadowing engine SSE1 logs off (block 543).

Once a person of the team of the organization ORG2 in charge of the execution of the activity A3, through the respective workflow client WfMS2_C, declares the activity A3 completed, or once an activity-implementing application completes successfully, the state-shadowing engine SSE2 sends to the state-shadowing engine SSE1 a notification UPD(PI1,A3,COMPL) (“update: completed activity A3 of process instance PI1(PT1)”). The state-shadowing engine SSE1 receives the notification UPD(PI1,A3,COMPL), logs onto the workflow server WfMS1_S using the assigned user identifier UIDx and, by management commands provided through the interface adapter component WfMS_IAC, causes the workflow server WfMS1_S to put the activity A3 in the completed state, thereby changing the state of the workflow management system WfMS1.

Depending on the result of the execution of the activity A3, the workflow management system WfMS2 then locates the activity A42 and posts it in the work list of the selected team of people.

The state-shadowing algorithm implementing component SH_ALG of the state-shadowing engine SSE2, looking at the shadow table SH_TAB2(PT1), detects that the activity A42 is classified as LOC and sends to the state-shadowing engine SSE1 a notification UPD(PI1,A42,START). The state-shadowing engine SSE1 receives the notification UPD(PI1,A42,START), and logs onto the workflow server WfMS1_S, using the assigned user identifier UIDX. Once logged on, the state-shadowing engine SSE1 causes the workflow server WfMS1_S to start the activity A42, thereby changing the state of the workflow management system WfMS1.

Once a person of the team of people of the organization ORG2 in charge of the execution of the activity A42, through the respective workflow client WfMS2_C, declares the activity A42 completed, or once an activity-implementing application completes successfully, the state-shadowing engine SSE2 sends to the state-shadowing engine SSE1 a notification UPD(PI1,A42,COMPL). The state-shadowing engine SSE1 receives this notification, logs onto the workflow server WfMS1_S using the assigned user identifier UIDx, and causes the workflow server WfMS1_S to put the activity A42 in the completed state, thereby changing the state of the workflow management system WfMS1.

The control of the workflow passes now to the workflow management system WfMS1 that, detecting that the activity A42 has been completed, locates the next activity A5 to be performed within the organization ORG1. The activity A5 is posted onto the work list of the team of people within the organization ORG1 in charge of the execution. The state-shadowing implementing algorithm SH_ALG of the state-shadowing engine SSE1, looking at the shadow table SH_TAB1(PT1), detects that the activity A5 is classified as LOC and sends to the state-shadowing engine SSE2 a notification UPD(PI1,A5,START). The state-shadowing engine SSE2 receives this notification and logs onto the workflow server WfMS2_S, using the assigned user identifier UIDy. Once logged on, the state-shadowing engine SSE2 provides to the workflow server WfMS2_S, through the respective interface adapter component WfMS_IAC, management commands causing the workflow server WfMS2_S to put the activity A5 in the start state, thereby changing the state of the workflow management system WfMS2.

Once the activity A5 is completed, the state-shadowing engine SSE1 sends to the state-shadowing engine SSE2 a notification UPD(PI1,A5,COMPL). The state-shadowing engine SSE2 receives this notification, logs onto the workflow server WfMS2_S using the assigned user identifier UIDy, and causes the workflow server WfMS2_S to put the activity A5 in the completed state, thereby changing the state of the workflow management system WfMS2.

The control of the workflow passes back to the workflow management system WfMS2 that, identifying the activity A5 as completed, locates the next activity A6 to be performed within the organization ORG2. The activity A6 is posted onto the work list of the team of people of the organization ORG2 in charge of its execution. The state-shadowing algorithm implementing component SH_ALG of the state-shadowing engine SSE2, looking at the shadow table SH_TAB2(PT1), detects that the activity A6 is classified as LOC and sends to the state-shadowing engine SSE1 a notification UPD(PI1,A6,START). The state-shadowing engine SSE1 receives this notification and logs onto the workflow server WfMS1_S, using the assigned user identifier UIDx. Once logged on, the state-shadowing engine SSE1 causes the workflow server WfMS1_S to start the activity A6, thereby changing the state of the workflow management system WfMS1.

Once the activity A6 is completed, the state-shadowing engine SSE2 sends to the state-shadowing engine SSE1 a notification UPD(PI1,A6,COMPL). The state-shadowing engine SSE1 receives this notification, logs onto the workflow server WfMS1_S using the assigned user identifier UIDx, and causes the workflow server WfMS1_S to put the activity A6 in the completed state, thereby changing the state of the workflow management system WfMS1.

In this way, the shadowed part of the business process is carried out. The control of the workflow passes back again to the workflow management system WfMS1, which posts the next activity A7, the end activity of the business process, onto the work list of the team of people of the organization ORG1 in charge of its execution. The state-shadowing algorithm implementing component SH_ALG of the state-shadowing engine SSE1, looking at the shadow table SH_TAB1(PT1), detects that the activity A7 is classified as NUL, and sends no further notifications to the state-shadowing engine SSE2.

It is observed that albeit in the foregoing only two kind of update notifications for each activity (start and completion of an activity) are exchanged between the state-shadowing engines, more notifications can be envisaged, each one associated with an operation performed on the activity within the organization in charge of the execution thereof. Responsive to each notification, the state-shadowing engines) of the other participating organization(s) will log onto the respective workflow server, providing thereto management commands corresponding to the notification received.

By exchanging notifications of state changes between the state-shadowing engines of different participating organizations, the state of one workflow management system is replicated in the other workflow management systems. Any organization, albeit not in charge of the execution of a given part of a common business process, can thus follow, looking at the respective local shadow of the process, the activities performed in the other participating organizations. In particular, this allows any participating organization controlling the workflow in another participating organization, and synchronizing the workflows in the different participating organizations.

Additionally, the execution of local activities by an organization can be made dependent on the state of remote activities executed in different participating organizations. For example, referring back to FIG. 4A, the execution of the activity A5 within the organization ORG1 is made dependent on the execution of the activity A42 within the organization ORG2, and the execution of the activity A6 within the organization ORG2 is made dependent on the execution of the activity A5 within the organization ORG1.

In the context of a customer organization (e.g., organization ORG1) that outsources a part of a business process to a provider organization (organization ORG2), the provision of the state-shadowing mechanism allows the provider organization to outsource some activities (e.g., activity A5 in FIG. 4A) back to the provider organization; this may be expedient where the business process is long and complex and where some activities and decisions should be brought back to the customer organization before continuing with the main outsourced part of the process.

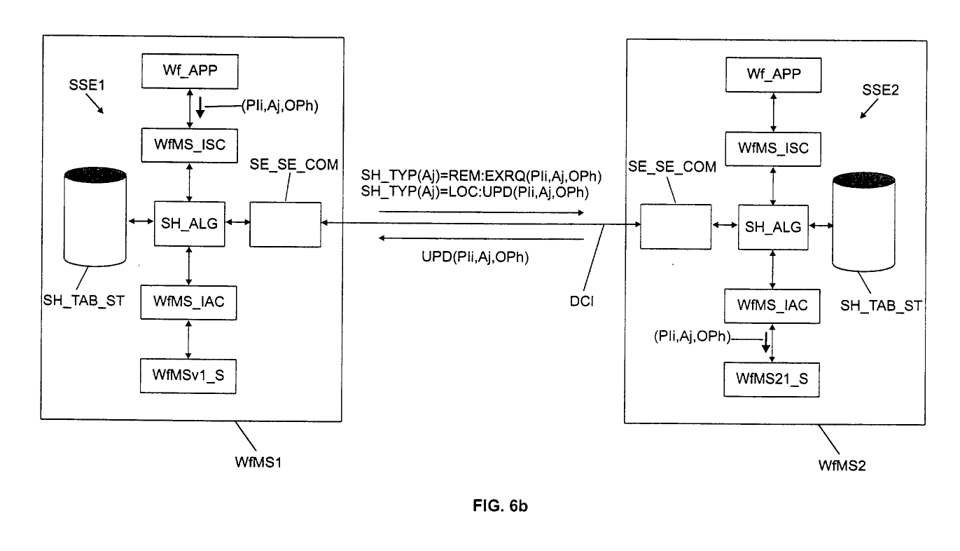

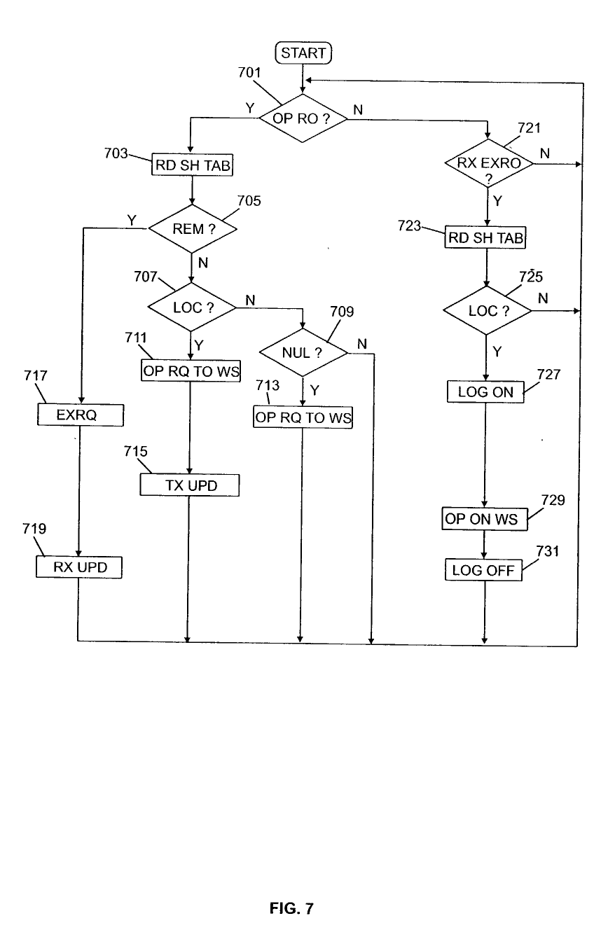

The provision of a shadowing mechanism also enables remote management of activities: remote activities, executed in a first participating organization, can be managed from a second participating organization in the same way as activities executed locally to the second organization are normally managed. As shown schematically in FIGS. 6A and 6B and in the flowchart of FIG. 7, let it be supposed that a user Ua, Ub in the organization ORG1 wants to perform, through a respective workflow application Wf_APP running on the workflow client WfMS1_C in the workflow management system WfMS1, an operation OPh on the activity Aj of the process instance PIi of a given process template. An operation request (PIi,Aj,OPh) is provided to the state-shadowing algorithm implementing component SH_ALG of the state-shadowing engine SSE1, through the interface simulation component WfMS_ISC. The state-shadowing algorithm implementing component SH_ALG, receiving the operation request (block 701 in FIG. 7) looks into the shadow table of the process instance stored in the shadow table store component SH_TAB_ST (block 703), to identify the class of the activity Aj (blocks 705, 707 and 709). If the activity Aj is classified as LOC or NUL, the state-shadowing algorithm implementing component SH_ALG allows the workflow application Wf_APP to log into the workflow server WfMS1_S, thereby the operation request (PIi,Aj,OPh) is transferred, through the interface adaptation component WfMS_IAC, to the workflow server WfMS1_S (block 711 or 713); the workflow server WfMS1_S changes its state in consequence to the operation OPh. Additionally, if the activity Aj is classified as LOC, and the state-shadowing algorithm implementing component SH_ALG notifies (UPD(PIi,Aj,OPh)-block 715) to the other participating organization ORG2 the change of state, so that the state of the workflow management system WfMS2 is correspondingly updated. If the activity is instead classified as REM, the state-shadowing algorithm implementing component SH_ALG sends to the state-shadowing engine SSE2 in the workflow management system WfMS2 in the other participating organization ORG2 a remote operation execution request EXRQ(PIi,Aj,OPh) (block 717) and waits for the notification of state update indicating that the operation has been executed (block 719); upon detecting the incoming remote operation execution request (block 721) the state-shadowing algorithm implementing component SH_ALG in the state-shadowing engine SSE2 looks into the shadow table stored in the respective shadow table store component SH_TAB_ST block 723) to verify that the activity Aj is classified as LOC, i.e. local to the organization ORG2 (block 725). In the negative case, the remote operation execution request EXRQ(PIi,Aj,OPh) is ignored, otherwise the state-shadowing angine SSE2 logs into the workflow server WfMS2_S (block 727) and supplies thereto the remote operation request (PIi,Aj,OPh) (block 729), logging then off (block 731); the workflow server WfMS2_S applies the operation to the activity Aj as if coming from one of the workflow applications Wf_APP running on the workflow clients WfMS2_C of the workflow management system WfMS2, thereby changing the state of the workflow management system WfMS2, then the state-shadowing engine SSE2 notifies ((UPD(PIi,Aj,OPh)) the change of state to the workflow management system WfMS1. Possible conflicts are resolved in the following way: if the state-shadowing engine SSE1, before receiving the remote operation execution request EXRQ(PIi,Aj,OPh), receives from one of the local workflow applications Wf_APP an operation execution request for the same activity Aj, thereby the state of the workflow management system WfMS2 is changed in such a way that the operation OPh specified in the remore operation execution request EXRQ(PIi,Aj,OPh) cannot be executed anymore, the remote command execution request EXRQ(PIi,Aj,OPh) is ignored. In other words, to resolve conflicts a strategy is adopted according to which operation execution requests local to the workflow management system of a participating organization have the priority over remote operation execution requests originating in other participating organizations.

The state-shadowing engine thus provides, in each workflow management system, a reference monitor for applications such as the workflow clients or other managing applications, providing the same functionality as the conventional interfaces of the workflow servers. The reference monitor determines the location of the activity on which a management operation is to be performed: if the activity is local to the organization where the management operation request is originated, the reference monitor allows the management operation to be performed by the local workflow management system, otherwise the management operation request is forwarded to the reference monitor of the workflow management system of the organization in charge of executing the activity. The strategy for resolving possible conflicts provides that the workflow management system in the organization in charge of executing an activity has the right to override management operation requests coming from the workflow management system of a remote organization.

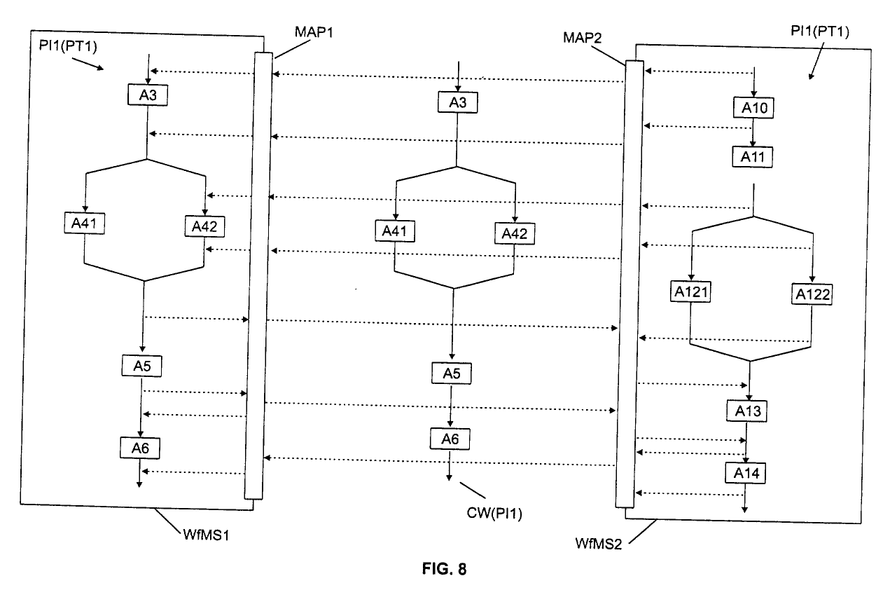

It is observed that the part of the common business process executed under the responsibility of one of the organizations participating to the common business process can differ, in terms of activities and/or order of execution, from the common view of the process agreed upon by all the workflow management systems. Referring to FIGS. 4A and 4B, this means for example that the process instance PI1′ (PT1) created in the workflow management system WfMS2 of the organization ORG2 can include different activities, with a different execution order, than those comprising the common view of the process shown in FIG. 4B. An example of this situation is depicted in FIG. 8, where it is shown a process instance PI1′ (PT1) differing from the common view CW(PI1) of the process. In particular, the process instance PI1′ (PT1) forms an internal representation of the common view CW(PI1) of the process, comprising the activities A10-A14. The state-shadowing engine SSE2 in the workflow management system WfMS2 implements a suitable mapping MAP of the real process PI1′ (PT1) to be executed within the organization ORG2 onto the common view of the process CW(PT1). The mapping shall guarantee that the messages exchanged between the two participating organizations ORG1 and ORG2 to notify the workflow progress are compatible with the common view of the process. Such a mapping can be for example implemented by the state-shadowing implementing algorithm component SH_ALG in the state-shadowing engine SSE2; in particular, the shadow table SH_TAB2(PT1) shown in FIG. 3B can be modified to allow a transcoding of the activities A3, A41, A42, A5 and A6 in the common view of the process into the real activities to be executed under the responsibility of the organization ORG2. Alternatively, the mapping can be implemented by the state-shadowing engine SSE1 in the workflow management system WfMS1.

More generally, the workflow management system of each participating organization may have a respective internal representation of the common view of the business process, and the respective state shadowing engine may implement a suitable mapping (MAP1 and MAP2 in FIG. 8) of the respective internal process representation onto the common view of the process. The provision of the common view of the process and the mapping allows any participating organization to have a respective internal representation of the common business process, chosen to best suit the internal needs of each organization, at the same time allowing information on the workflow progress to be exchanged between the different participating organizations.

The described system and method is applicable in general whenever multiple organizations participate to carrying out a business process under the control of computer-based process management systems. The state-shadowing mechanism allows all the participating organizations tracking the business process progress.

The described system and method is also applicable to the management of a business process within a single organization, in which different entities within the organization, for example different teams or departments, participate to carrying out the business process, by relying on respective workflow management systems. More generally, the different entities participating to the management of the business process can include entities belonging to a same organizations and entities belonging to different organizations.

Although the present invention has been disclosed by way of some embodiments, it is apparent to those skilled in the art that several modifications to the described embodiments, as well as other embodiments of the present invention are possible, without departing from the scope thereof as defined in the appended claims. By way of example only, and not at all exhaustively, the workflow management systems may adopt different communication protocols; different login and logoff policies may be envisaged; the information on state changing events may be communicated by the workflow server to the respective state-shadowing algorithm implementing component, instead of being detected by the latter by regularly polling the workflow server.

What is claimed is:

1. A method of managing a workflow distributed among at least two participating entities by means of respective distinct computer-based workflow management systems in each entity, each workflow management system managing a respective workflow part of the distributed workflow, the method comprising the steps of:
defining a common specification of the distributed workflow to be used as a reference by the distinct workflow management systems, the common workflow specification specifying which workflow management system is in charge of managing which workflow part;
creating in each distinct workflow management system an image of the distributed workflow;
based on the common workflow specification, communicating to the distinct workflow management system of one entity the progress of the workflow part managed by the distinct workflow management system of the other entity; and
effecting in the notified workflow management system, an updating of an indication of progress in the image of the distributed workflow in line with the progress of the corresponding workflow part managed by the workflow management system of the other entity.

2. The method according to claim 1, wherein said step of defining a common workflow specification further comprises:
creating in each distinct workflow management system a table of activities comprising the common workflow specification, the table containing, for each activity, an activity classifier classifying the activity as one of a local activity to be managed locally by the distinct workflow management system and a remote activity to be managed remotely by another distinct workflow management system.

3. The method according to claim 2, wherein the table is created in the distinct workflow management system to contain, for a local activity to be managed locally by the distinct workflow management system, an address of the other distinct workflow management system to which information on the execution of the local activity is to be communicated, and, for a remote activity to be managed remotely by the other distinct workflow management system, an address of the workflow management system in charge of managing the execution of the remote activity.

4. The method according to claim 3, further comprising:
in each distinct workflow management system, looking at the respective table for handling activity management commands originating locally at the distinct workflow management system, and
if the activity is classified as a local activity, allowing managing the execution of the activity management command locally at the distinct workflow management system;
if the activity is classified as a remote activity, forwarding the activity management command to the distinct workflow management system in charge of managing the execution of the activity according to the address specified in the table.

5. The method according to claim 4, further comprising:
in the event that one of the distinct workflow management systems receives the activity management command from another distinct workflow management system, managing the execution of the received activity management command if it is not in conflict with a current state of execution of the respective workflow part, otherwise ignoring the received activity management command.

6. The method according to claim 1, wherein said step of creating a distributed workflow image comprises:
in each distinct workflow management system, creating an internal workflow representation of the common workflow specification, and mapping the common workflow specification onto the internal workflow representation.

7. A computer-based system for managing a workflow distributed among at least a first and a second participating entity, the system comprising:
a first workflow management system in the first entity, managing a first workflow part of the distributed workflow;
a second workflow management system in the second entity, managing a second workflow part of the distributed workflow, the first and second workflow management systems being distinct and in communication relationship,
wherein each one of the distinct first and second workflow management systems comprises:
means for defining a common specification of the distributed workflow, the common workflow specification specifying which one of the distinct first and second workflow management systems is in charge of managing which workflow part;
means for creating an image of the distributed workflow;
means for exchanging information between the distinct workflow management systems and for keeping the distinct workflow management system of one entity updated in the respective distributed workflow image, of the progress of the workflow part managed by the distinct workflow management system of the other entity according to the exchanged information.

8. The system according to claim 7, wherein the common specification comprises, in each distinct workflow management system, a table of activities comprising the common workflow specification, the table containing, for each activity, an activity classifier classifying the activity as one of a local activity to be managed locally by the distinct workflow management system and a remote activity to be managed remotely by another distinct workflow management system.

9. The system according to claim 8, wherein the table contains, for a local activity to be managed locally by the respective distinct workflow management system, an address of the other distinct workflow management system to which information on the execution of the local activity is to be communicated, and, for a remote activity to be managed remotely by the other distinct workflow management system, an address of the distinct workflow management system in charge of managing the execution of the remote activity.

10. The system according to claim 8, wherein each distinct workflow management system comprises:
a workflow server;
at least one workflow client,
said means for exchanging information and keeping the distinct workflow management system updated, interacting with the workflow server as a workflow client.

11. The system according to claim 10, further comprising monitoring means for routing activity management commands originating from the at least one workflow client according to the activity classifier, so that:
if the activity is classified as a local activity, the monitoring means routes the activity management command to the workflow server, such that the execution of the activity management command is managed locally by the distinct workflow management system;
if the activity is classified as a remote activity, the monitoring means forwards the activity management command to the workflow management system in charge of managing the execution of the activity according to the address specified in the table.

12. The system according to claim 7, wherein at least one of the distinct workflow management systems further comprises mapping means for mapping the common workflow specification onto the respective image of the distributed workflow.

13. The system according to claim 7, wherein the at least two participating entities belong to one of a same organization and different organizations.
